(19) United States
(12) Patent Application Publication
(10) Pub. No.: US 2015/0348043 A1
(43) Pub. Date: Dec. 3, 2015

(54) METHOD OF IDENTIFICATION, CORRESPONDING DEVICE AND PROGRAM

(71) Applicant: Ingenico Group, Paris (FR)

(72) Inventor: Michel Leger, Saint Germain En Laye (FR)

(21) Appl. No.: 14/724,044

(22) Filed: May 28, 2015

(30) Foreign Application Priority Data
May 28, 2014 (FR) 1454863

(51) Int. Cl. G06Q 20/40

(52) U.S. Cl. CPC G06Q 20/4016; G06Q 20/405

(57) ABSTRACT

A method and device are provided for method for identifying a user for access to an article or a service. The method includes: presentation to a terminal, by the user to be identified, of a payment card; execution, by the terminal, of a payment transaction, the amount of which is zero; and when said payment transaction is executed without error, issuing an assertion of identification leading to access to the article or service.

### 1. CROSS-REFERENCE TO RELATED APPLICATIONS

This Application claims the benefit of and priority to French Patent Application No. 14 54863, filed May 28, 2014, the content of which is incorporated herein by reference in its entirety.

### 2. FIELD OF THE DISCLOSURE

The disclosure relates to the field of identification.

More particularly, the disclosure relates to the identification of individuals by means of an identification element. In the context of the disclosure, such an identification element is understood to be a payment card such as a credit card or other payment card. Such cards are widely used by many people throughout the world for payment operations. They are generally distributed by banking institutions or by payment service providers. A card is generally issued to a holder, as a rule, a bank customer. This holder, who is a customer of the bank or of the payment service provider, generally receives a personal identity code which he can or must use with the payment card (depending on the constraints governing the authorization and/or the country in which the card is used). These cards are delivered after a relatively careful examination of the identity of the applicant (who is, for example, the customer of the bank). This examination entails the furnishing of identity papers, proof of residence, etc.

### 3. PRIOR ART

At present, a difference is made between systems of identification (for obtaining identity checks) and systems of authentication (which certify identity). Indeed, an identity check does not use the same techniques as an authentication of identity: authentication is generally strong whereas identification is relatively weak by comparison.

There are numerous situations in which a person or an individual needs to be identified. A common situation for example is that of stating one's identity when going to a meeting. As a rule, the fact of stating one's identity does not constitute a very strong proof of identity and this type of identification is not used in practice except when the identification is not of very great importance. The situation is different, for example, when entering a protected site or accessing sensitive data. This is the case for example in a company. Access to the premises of a company is generally restricted to a limited number of persons. These are for example the employees of the company or to a lesser extent the company's customers and suppliers. Often, the employees are identified by means of a badge which is used as an access key to the company's premises. The customers and suppliers for their part have to go up to the company's reception desk and furnish an identity document.

The checking, as such, of a person's identity document can be done only through a physical person responsible for checking a person's identity. In situations where a physical person is not fully employed in making identity checks, automated systems are used (using access codes on keypads, badge readers, etc.). Automated identification systems are numerous and often costly.

When authentication has to be done, there are existing systems that are even costlier. These often implement biometrical recognition means (fingerprints for example). Such systems are reserved for access to extremely sensitive premises or to data or devices of the same type.

### 4. SUMMARY

An exemplary embodiment of the present disclosure offers a simple and low-cost solution enabling access to goods or services while at the same time using an existing architecture of identification. An exemplary embodiment relates to a method for identifying a user for access to an article or a service. Such a method comprises:

a step of presentation to a terminal, by the user to be identified, of a payment card;

a step of execution, by the terminal, of a payment transaction, the amount of which is zero;

when said payment transaction is executed without error, a step for issuing an assertion of identification leading to access to the article or service.

Thus, the proposed technique makes it possible to allow access to an article or a service with an existing payment card belonging to the user. This technique avoids resorting to the manufacture of new cards to manage these cases of access.

According to one particular characteristic, the step for executing a payment transaction of a zero amount is adapted, in types of checks performed conjointly between the payment card and the terminal, to a degree of sensitivity of the access.

Thus, the application implemented within the terminal, which is appreciably identical to a payment application, is adapted to the sensitivity of the information or the goods or services which must be accessed, and this is done without having to provide for a physical modification of the terminal.

According to one particular embodiment, the step for executing a payment transaction of a zero amount comprises a step for the entry, by said user, of a personal identification code on a keypad of the terminal.

Thus, the user cannot deny that he has accessed the article or service: indeed, the entry of the personal identification code provides almost total certainty about the user's identity.

According to one particular characteristic, the step for executing a transaction for paying a zero amount comprises a step for transmitting a request of authorization to a server connected to said terminal by means of a communications network.

Thus, although it is a zero amount transaction, this transaction is subject to online acceptance by a server in charge, thus making certain that the card is not one that has been posted as a stolen card.

The present disclosure also relates, in at least one embodiment, to a device for identifying a user for access to an article or a service. According to a particular characteristic, such a device comprises:

means of presentation of a payment card by the user to be identified;

means of execution of a payment transaction, the amount of which is zero;

means for issuing an assertion of identification leading to access to the article or service.

Such a device naturally, in its most common shape, takes the form of a terminal. Such a terminal makes use of an existing infrastructure which is the infrastructure forming the interbank card payment system. The terminal can advantageously be connected to such a system in order to be able to implement, besides, at least some of the steps of the proposed method.

According to an exemplary implementation, the different steps of the methods are implemented by one or more software programs or computer programs comprising software instructions intended for execution by a data processor of a relay module according to an embodiment of the disclosure and being designed to command the execution of the different steps of the method.

Consequently, an exemplary embodiment is also aimed at providing a program, capable of being executed by a computer or by a data processor, this program comprising instructions to command the execution of the steps of a method as mentioned here above.

This program can use any programming language whatsoever and take the form of a source code, object code or an intermediate code between source code and object code, such as in a partially compiled form or in any other desirable form whatsoever.

The disclosure is also aimed at providing an information carrier readable by a data processor and comprising instructions of a program as mentioned here above.

The information carrier can be any entity or device whatsoever capable of storing the program. For example, the medium can comprise a storage means such as a ROM, for example a CD ROM or a microelectronic circuit ROM or again a magnetic recording means such as floppy disk or a hard disk drive.

Besides, the information carrier can be a transmissible carrier such as an electrical or optical signal, which can be conveyed via an electrical or optical cable, by radio or by other means. The program according to the an exemplary embodiment can especially be uploaded to an Internet type network.

As an alternative, the information carrier can be an integrated circuit into which the program is incorporated, the circuit being adapted to executing or to being used in the execution of the method in question.

One embodiment of the disclosure is implemented by means of software and/or hardware components. In this respect, the term “module” in this document can correspond equally well to a software component as to a hardware component or to a set of hardware or software components.

A software component corresponds to one or more computer programs or several sub-programs of a program or more generally to any element of a program or a software package capable of implementing a function or a set of functions, according to what is described here below for the module concerned. Such a software component is executed by a data processor of a physical entity (terminal, server, gateway, router, etc) and is capable of accessing hardware resources of this physical entity (memories, recording media, communications buses, input/output electronic boards, user interfaces, etc).

In the same way, a hardware component corresponds to any element of a hardware assembly capable of implementing a function or a set of functions according to what is described here below for the module concerned. It may be a programmable hardware component or a component with an integrated processor for the execution of software, for example an integrated circuit, a smartcard, a memory card, an electronic card for executing firmware, etc.

Naturally, each component of the system described here above implements its own software modules

The different embodiments mentioned here above can be combined with one another to implement one or more embodiments of the disclosure.

### 5. DRAWINGS

Other features and advantages shall appear more clearly from the following description of a preferred embodiment, given by way of a simple illustratory and non-exhaustive example, and from the appended drawings, of which:

FIG. 1 presents an architecture on which the proposed technique is based;

FIG. 2 presents a block diagram of the proposed technique;

FIG. 3 describes a device for implementing the proposed technique.

### 6. DESCRIPTION

### 6.1. Reminders

The general principle of the proposed technique relies on the use of a payment terminal for purposes of identification. More particularly, the proposed technique consists of the use of the general architecture of the system for payment by payment card for purposes of identification.

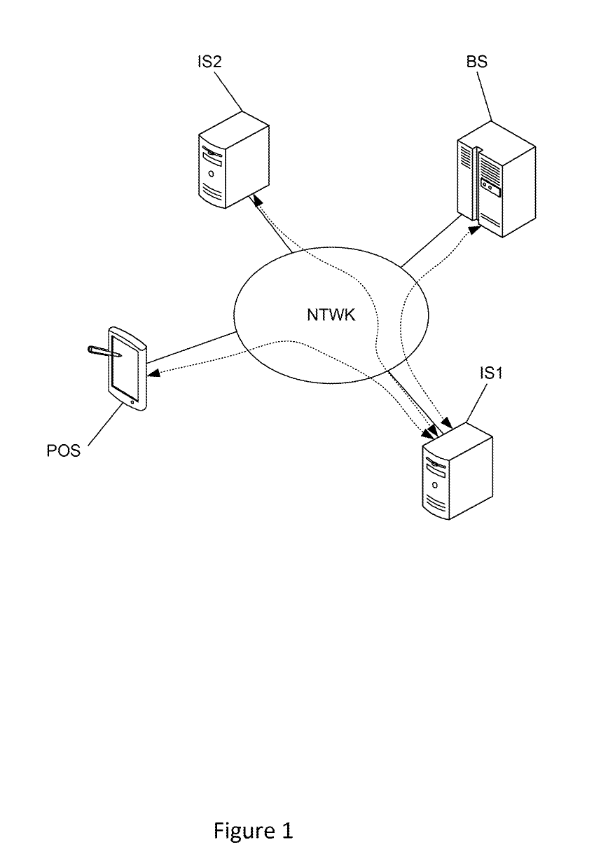

Referring to FIG. 1, we describe an architecture of a payment system as implemented at the present time. Such a system (51) comprises at least one payment terminal (POS) (only one terminal is shown in the figure), a bank server (BS) (or a server of a payment service provider). This payment server (POS) and this bank server (BS) are connected firstly by means of a communications network (NTWK) (either a 3G type wireless network or a wire network) and possibly by a first intermediate server (IS1).

Depending on the services, the payment terminal may be not directly connected to the bank server. It is connected for example to an intermediate server which acts a proxy/buffer/accreditor (this intermediate service can be the bank server corresponding to the merchant's bank). The intermediate server (IS1) can itself be connected to at least one other intermediate server (IS2) which is for example the server corresponding to the payment card (Visa, MasterCard, American Express, etc.) issuing institution. It is then these second-line intermediate servers that are connected to bank servers. The intermediate server (IS1) can be directly connected to the other bank servers (other banks and/or payment service providers).

When a transaction has to be performed from a payment terminal (POS), the payment terminal (POS) gets connected for example to the first intermediate server (IS1), especially when authorization of payment has to be requested. Depending on the amount of the transaction, the intermediate server (IS1) can itself provide the authorization needed or can request authorization from another server. From amongst all the servers to which it has access (IS2, BS, etc.), the intermediate server (IS1) selects the appropriate server according to the payment card (CB) which is present in the payment terminal (POS) and requests authorization from this server. Naturally, these transmissions are encrypted by means of cryptographic materials distributed among the different actors in order to ensure absence of fraud and authenticity of the information exchanged.

Besides, a set of protocols called “EMV” protocols is implemented in order to obtain, from the payment card, the data needed for the transaction. The proposed technique is based on this architecture.

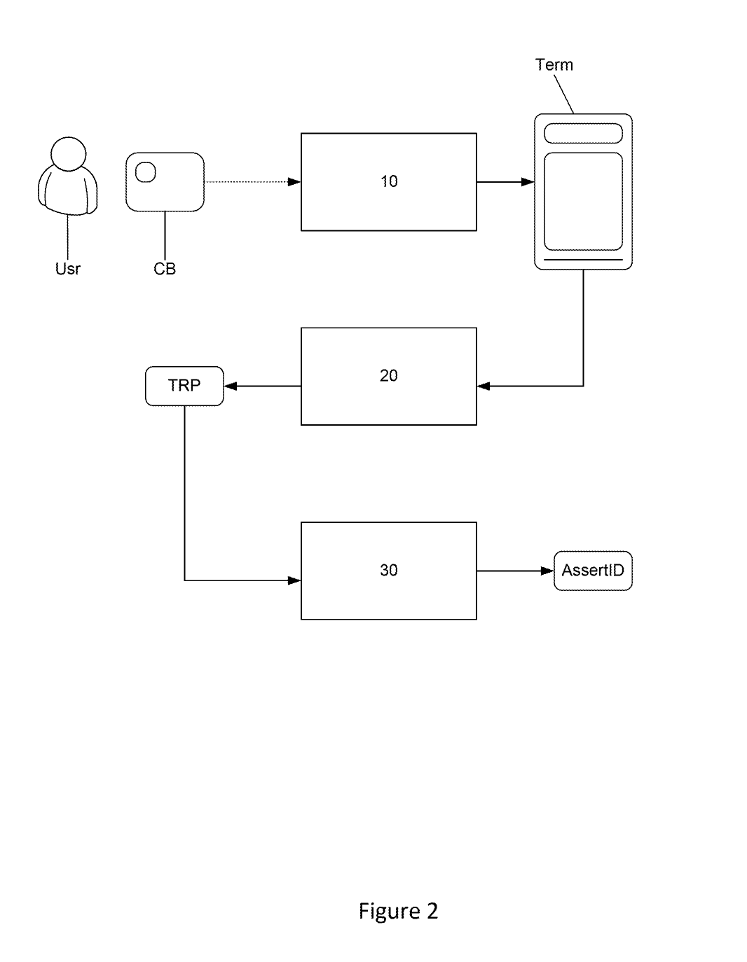

The proposed technique described with reference to FIG. 2 comprises the following steps:

a step (10) in which the user to be identified (Usr) presents a payment card (CB) to a terminal (Term);

a step (20) for the execution by the terminal (Term), of a payment transaction (TrP), the amount of which is zero;

when said payment transaction is executed without error, a step (30) for issuing an assertion of identification (AssertlD) leading to access to the article or to the service.

The presentation of the payment card can consist of the insertion of this card into a payment card reader or again the use of a mode of contactless communications with the payment card (NFC) or any other method for presenting a payment card. More particularly, at least two embodiments of the proposed technique can be implemented. In a first embodiment, a user is identified by generating a fictitious transaction for a zero amount (0 [symbol] ). The implementation of such a transaction, which is simple, makes sure that the user of the payment card on which the holder's name is recorded possesses the information on the personal identification code needed to validate the transaction (when the personal identification code is used). In principle therefore, when the personal identification code is accurate, the user of the payment card is assumed to be the person he claims be.

When the personal identification code does not need to be entered, only the validity of the card is ensured. This variant is particularly well suited for example to replacing the use of magnetic cards, RFID cards or temporary codes. Indeed, for example to access a hotel room, the hotel often provides the customer with a magnetic card. This card is slotted into a reader present on the door of the room and causes the door to be opened. Using the technique of an exemplary embodiment of the present disclosure, it is not necessary to use an additional card: the user's personal card is used instead of the magnetic card to access the room. When inserting the card, a bank transaction whose amount is equal to zero Euros is prepared by the card reader (for example integrated into the door of the hotel room). This transaction is transmitted either to the first intermediate server or to the second intermediate server. This intermediate server validates the transaction and in return transmits a piece of data representing the validation of the terminal. When this terminal receives the validation, it authorizes the requested action (for example opening the door). As an alternative, the terminal requests no validation. A transaction for a zero amount is prepared or built. When it is possible to prepare this transaction (i.e. when the terminal is in the presence of a valid payment card or credit card), then the simple fact of being able to prepare the transaction enables access to the product or service desired. Naturally, in addition to preparing this transaction, the terminal ascertains that the identifier of the payment card corresponds to an expected identifier (the identifier being for example the payment card number). For access to a hotel room for example, it is noted that this identifier is necessarily known. Indeed, to be able to pay for the hotel room, the user must present a valid payment card or credit card to the hotel reception desk: the number of the payment card is then already known. Thus, in this embodiment, the system for managing hotel rooms is greatly simplified since it is not necessary to have a complementary system available for preparing access magnetic cards. This embodiment can naturally be derived from other types of access to goods or services.

When the personal identification code needs to be entered, additional security is provided in addition to that of existing systems. Indeed, a check is then made to ensure that access to the article or to the service is possible only for the holder of the card who also has the personal identification code of this card. This is interesting when access to the article or service requires heavy checks. For example, this type of operation can be adapted to a device for taking registered mail, which may be set up in postal systems. The user who receives notice that a registered letter is available can then go to the post office and use a robotic device that makes it possible to recognize the holder of the payment card, identify the registered mail waiting for this holder, request through the terminal the entry of the personal identification code and carry out a transaction with a zero amount. When the terminal receives authorization from the server, it orders the robotic device to deliver the registered mail to the user. It then becomes possible to obtain goods and services far more securely and speedily than before. More particularly, the present technique can be implemented in situations of access to goods and/or services in an unattended manner. This applies to any type of dispenser for which an identification or authentication of a user (or a customer) is necessary without there being any need however for a financial transaction: access to a parking lot, opening a door, access to a workplace, etc.

In another embodiment, complementary to the embodiments presented here above, a transaction is performed with each use of the payment card to carry out an identification operation. As explained here above, in one basic embodiment, the transaction has an amount fixed at zero. In addition, in this basic embodiment, the transaction also comprises the “merchant's” identity, i.e. the identity of the supplier of access to the article or service. In the example of the hotel, this is the name of the hotel. The transaction also comprises a label, prepared according to the desired action. In the example of the hotel, this label pertains for example the time of use.

In this embodiment, although it takes the form of a basic embodiment, a degree of subtlety is introduced at the level of the application managing the transactions of identification/authentication (the application installed within the terminal). It may be recalled that an exemplary principle of the disclosure involves the use of an architecture of a general payment system to carry out identification/authentication operations. Depending on the situation, and, more particularly, depending on the article or service to which access is to be provided with the payment card, the application installed within the terminal will not necessarily work in the same way. Thus, in the case of “simple” access, the transaction can be performed without requiring authorization from a server (offline transaction): this is for example the case of access to a hotel room. In this case, the phase for managing risks on the terminal side is not implemented. The appropriate bit of the “terminal verification results” of the EMV protocol is set at 0.

In the case of “sensitive” access (i.e. when the goods or services to which access is sought are considered to be sensitive, such as for example registered mail), the transaction is still conducted “online”, i.e. in requesting authorization from a server (for example a bank server). In this case, the bit 4 of the byte 4 of the “terminal verification results” of the EMV protocol is positioned at 1, in order to force an online transaction.

As a corollary, generating a transaction enables the user to have available, in his bank statement, all the uses to which his payment card has been put, whether it is to make payments or to obtain access to an article or to a service. This means that the bank statement is transformed into a statement of actions.

In one embodiment of greater complexity, the payment terminal is used not to enable access to goods or services but to carry out an authentication of an action of the payment card holder. In such an embodiment, the transaction performed by the payment terminal represents an identified object. It is for example a piece of data.

### 5.2. Other features and Advantages

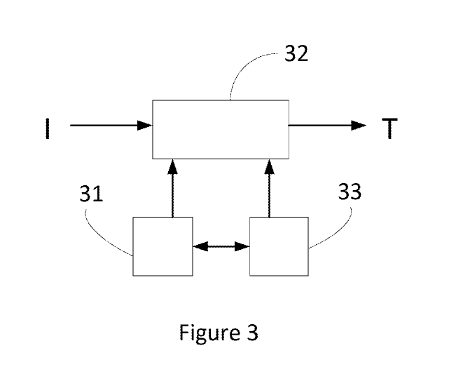

Referring to FIG. 3, we describe a device implemented to identify a user according to the method described here above.

For example, the device comprises a memory 31 constituted by a buffer memory, a processing unit 32, equipped for example with a microprocessor and driven by the computer program 33 implementing a method of identification.

At initialization, the code instructions of the computer program 33 are for example loaded into a memory and then executed by the processor of the processing unit 32. The processing unit 32 inputs a piece of activation data (for example pressure on a button or a digital activation command). The microprocessor of the processing unit 32 implements the steps of the method of identification according to the instructions of the computer program 33 to request the presentation of a payment card (either by insertion into a card reader or by contactless transmission) to carry out a financial transaction for a zero amount and to deliver an assertion of identification when this transaction is executed accurately.

To this end, the computer comprises, in addition to the buffer memory 31, communications means such as a network communications modules, data transmission means and an encryption processor.

These means can take the form of a particular processor implemented within the device, said processor being a secured processor. According to one particular embodiment, this device implements a particular application that is in charge of performing transactions. This application can for example be provided by the manufacturer of the processor in question in order to enable the use of said processor. To this end, the processor comprises unique means of identification. These unique means of identification make it possible to ensure the authenticity of the processor.

Besides, the device additionally comprises means for authorizing access to an article or a service such as means for activating opening (of doors for example). These means also take the form of communications interface enabling the exchange of data on communications networks, interrogation means and database updating means, etc.

Although the present disclosure has been described with reference to one or more examples, workers skilled in the art will recognize that changes may be made in form and detail without departing from the scope of the disclosure and/or the appended claims.

1. A method identifying a user for access to an article or a service, wherein the method comprises:
presenting to a terminal, by the user to be identified, a payment card;
executing, by the terminal, a payment transaction, the amount of which is zero; and
when said payment transaction is executed without error, issuing an assertion of identification leading to access to the article or to the service.

2. The method for identifying according to claim 1,
wherein executing a payment transaction of a zero amount is adapted, in types of checks performed conjointly between the payment card and the terminal, to a degree of sensitivity of the access.

3. The method for identifying according to claim 1,
wherein executing a payment transaction of a zero amount comprises entering, by said user, a personal identification code on a keypad of the terminal.

4. The method for identifying according to claim 1,
wherein executing a transaction for paying a zero amount comprises transmitting a request of authorization to a server connected to said terminal by means of a communications network.

5. A device for identifying a user for access to an article or a service, device comprising:
means for presentation of a payment card by the user to be identified;
means for execution of a payment transaction, the amount of which is zero;
means for issuing an assertion of identification leading to access to the article or service.

6. A non-transitory computer-readable medium comprising a computer program product stored thereon and comprising program code instructions for identifying a user for access to an article or a service, when the instructions are executed on a processor of a terminal device, wherein the instructions comprise:
instructions that configure the terminal device to receive a payment card presented to the terminal by the user to be identified;
instructions that configure the terminal device to execute a payment transaction, the amount of which is zero; and
instructions that configure the terminal device to, when said payment transaction is executed without error, issue an assertion of identification leading to access to the article or to the service.
